(19) United States
(12) Patent Application Publication
(10) Pub. No.: US 2004/0261170 A1
(43) Pub. Date: Dec. 30, 2004

(54) Method for providing therapeutic treatment

(76) Inventor: Henry Brunelle, Cap-Rouge (CA)

Correspondence Address: OGILVY RENAULT, 1981 MCGILL COLLEGE AVENUE, SUITE 1600, MONTREAL, QC, H3A2Y3, CA

(21) Appl. No.: 10/460,225

(22) Filed: Jun. 13, 2003

(51) Int. Cl. A61H 33/06

(52) U.S. Cl. 4/524

(57) ABSTRACT

A therapeutic treatment method comprising the steps of: providing equipment for complementary therapeutic treatments. The equipment is any one of a hot-air enclosure, an air-jet water bath and a massage table. The equipment is confined to a single room in a side-by-side relationship, such that a person may undergo the therapeutic treatment with the equipment and a masseur person. The equipment may also be confined to a demonstration room, so as to sell packages of equipment as shown in the demonstration room.

### TECHNICAL FIELD

The present invention generally relates to therapeutic treatments and, more particularly, to a method of combining some therapeutic treatments and making them more readily available in a single room (bathroom, hotel room or house spa room) so as to provide increased health benefits to people.

### BACKGROUND ART

Today's hectic lifestyle is partly responsible for the advent of therapeutic treatments to heal the body and the soul. Massages, spas, baths, showers, chromotherapy and saunas are amongst the therapies and services to which today's overachievers, or simply achievers, have recourse to escape the busyness of their schedules. Health centers offering therapeutic services have spread throughout the world and, more particularly, in big cities close to business area. As an example, hotels frequently offer such services for the well-being of their guests. It is known that work-related travelers often have recourse to such treatments. However, larger spas are impersonal and not very intimate, and thus suffer from a lack of popularity.

The treatments involve elements such as water, air, heat and light, these elements being combined or taken individually to procure various states of well-being for the person being treated. As an example, chromotherapy is a therapy in which light of various colors is projected onto the person being treated, with the color of the light providing various results. As described at www.bainultra.com:

Red is stimulating and exciting. Red activates the circulation and wakes up the senses.

Orange is soothing and pain-relieving. Orange stimulates the respiratory system and soothes muscular pain.

Yellow is digestive and creative. Yellow promotes digestion and increases brain activity.

Green is calming and stabilizing. Green relaxes the entire body and stabilizes emotions.

Blue is relaxing and soothing. Blue reduces blood pressure and stress, and soothes the soul.

Violet is immunizing and tranquilizing. Violet stimulates the immune system, detoxifies and body and reduces anxiety.

These are a few states that a person reaches because of therapeutic treatment. Other therapies bring other states and feelings. Some of the states in which the person is left are complementary to others. A person coming out of a spa is typically in a calm and relaxed state. If massage treatments, which are complementary to a bath, were readily available, the person being treated could be influenced into requesting a massage. Strategically, providing easy access from a therapeutic treatment to another could possible entice persons being treated to go from treatment to treatment, for undergoing complete therapy.

### SUMMARY OF INVENTION

Therefore, it is a feature of the present invention to provide a method of providing therapeutic treatments which are complementary to one another and made readily available in a single room so as to provide increased health benefits to the person being treated.

It is a further feature of the present invention that the method provide a maximization of use of these therapeutic treatments.

Therefore, in accordance with the present invention, there is provided a therapeutic treatment method comprising the steps of i) providing equipment for at least two complementary therapeutic treatments, said equipment being a hot-air enclosure, an air-jet water bath and a massage table; ii) confining said equipment for said at least two complementary therapeutic treatments to a single room with said equipment disposed in a side-by-side relationship; and iii) undergoing therapeutic treatment with said equipment and a masseur person.

Further in accordance with the present invention, there is provided a method for selling therapeutic treatment packages for any one of home, hotel, or condo use, comprising the steps of i) providing equipment for at least two complementary therapeutic treatments; ii) confining said equipment for said at least two complementary therapeutic treatments to a demonstration room; and iii) selling packages of equipment as shown in said demonstration room.

### BRIEF DESCRIPTION OF DRAWINGS

A preferred embodiment of the present invention will now be described with reference to the accompanying drawings in which:

FIG. 1 is a top plan view of an arrangement of therapeutic treatments in accordance with the present invention.

### DESCRIPTION OF PREFERRED EMBODIMENTS

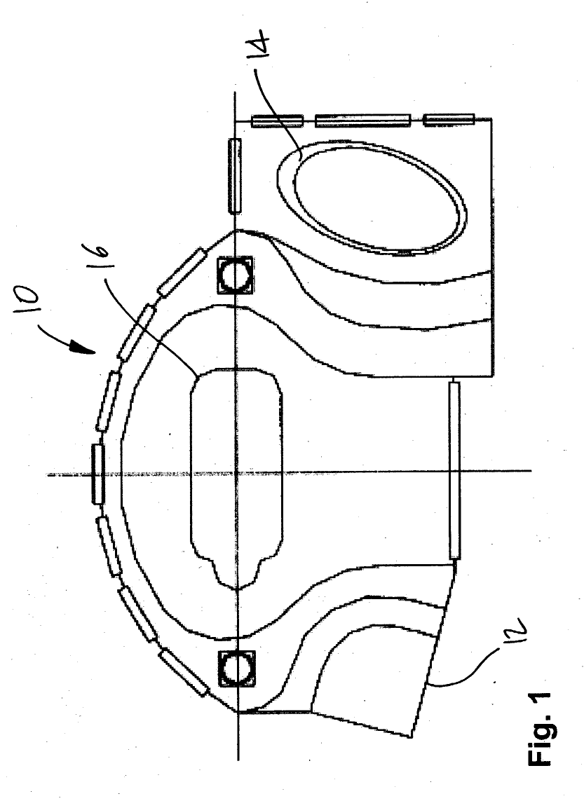

Referring to FIG. 1, an arrangement of therapeutic treatment stations is generally shown at 10. A therapeutic hot-air enclosure is shown at 12, a bath is shown at 14, and a massage table is shown at 16, all located in a single room in side-by-side relationship.

The therapeutic hot-air enclosure 12 is preferably as described in copending U.S. application Ser. No. 10/173,637 by the present applicant and incorporated herewith by reference. The therapeutic hot-air enclosure of U.S. application Ser. No. 10/173,637 has an enclosure in which an air blower is mounted above the top wall of the enclosure in communication with one or more air return orifices in the top wall. An air distribution channel is in communication with the air blower and one or more air-injection orifices are provided and communicate with the enclosure. A heater is provided in the air distribution channel for heating convected air therein to a temperature of up to about 75° C. to provide a stream of hot dry air circulating in the enclosure about a person's body standing therein whereby to cause the person's body to transpire and provide a therapeutic effect of shedding toxins through the skin. In combination with the hot dry air treatment also called thermotherapy, there is available a chromotherapeutic and luminotherapeutic light treatment—and an ion and ozone generator to inject ions and ozone into the hot dry air stream.

The advantages of the therapeutic hot-air enclosure of U.S. application Ser. No. 10/173,637 are many, and namely to cleanse the skin through dry-heat sweating process, to purify nasal passages by clearing mucous membranes, to reduce stress levels and pain by stimulating the production of endorphins (the “feel-good” hormones), to increase body heat reproducing the effects of a high fever, warding off viruses and other accumulated toxins or harmful metal such as lead and mercury, chemical products or fungus present in the body.

Regular sweating sessions offer a myriad of health advantages. In addition to relieving aches and pains related to rheumatism, arthritis and other chronic diseases, they can relieve cold and flu symptoms and congestion, alleviate the discomfort and pain of various skin diseases, as well as bring a strengthened immune system to better health in general.

Strategically, the bath 14 is in the vicinity of the therapeutic hot-air enclosure 12. The bath treatment is complementary to the sweating session of the therapeutic hot-air enclosure 12. The bath treatment will allow the sweat to be washed off. The water temperature of the bath may also be controlled so as to lower the body temperature, and procure a refreshing sensation to the bather.

The bath 14 is preferably an Ultra Thermo-masseur® bath as described at www.bainultra.com, and in which air jets create an acupressure effect. Additionally, the Ultra Thermo-masseur® bath can be complemented by chromotherapy, luminotherapy and aromatherapy (e.g., by way of oils being added to the water), so as to relax the body.

The massage table 16 is complementary to the bath 14. The person coming out of the bath 14 will be physically relaxed and physically disposed to be massaged. The person being treated will be inclined to extend the therapy session, to maintain this state of well-being.

The arrangement of therapeutic treatment stations shown in 10 is well suited for larger hotels that offer such therapeutic treatments, yet may also be adapted to private homes or condos for personal use. Rather than having larger therapy areas to which the customer must go, e.g., larger bath, sauna, separated from one another, there could be advantageously provided a plurality of arrangements of on-site therapeutic treatment stations such as described above, each of the arrangements of stations preferably being offered to one person at a time for given time periods. The fact that the therapeutic treatments are available on site increases their appeal. Also, the fact that a person being treated does not have to go from room to room to switch therapies is another factor that encourages persons being treated to extend their treatments. According to the present invention, it is the therapist who goes to the client and not the client who goes to the spa. This customer-driven approach will increase the appeal of the therapies by their convenience. The therapist, preferably habilitated for all therapies, will be available in the complete in-room or in-house spas of the present invention. The therapies will, therefore, be more personal and intimate.

Accordingly, hotels equipped with the therapeutic treatment stations 10 of the present invention in client suites may have therapists on standby to offer at any moment therapies to clients in need. Once the therapy is finished, the client is left in his room, where he/she may recuperate from the therapy. As the stations are in his/her room, the client has the exclusive use of them, whereby he/she may, for instance, freely take a nap on the massage table 16.

It is also contemplated to offer such arrangements as packages to homeowners or contractors. The combination of complementary treatments being sold as a concept that can fit into one room is an influential arrangement.

Because of the development of the therapeutic hot-air enclosure 12, it is now feasible to provide a compact integrated spa, which uses very little floor space, and which has made it possible to provide the innovative therapeutic treatment method and commercialization as described and claimed herein.

It is within the ambit of the present invention to cover any obvious modifications of the embodiments described herein, provided such modifications fall within the scope of the appended claims.

1. A therapeutic treatment method comprising the steps of:
i) providing equipment for at least two complementary therapeutic treatments, said equipment being a hot-air enclosure, an air-jet water bath and a massage table;
ii) confining said equipment for said at least two complementary therapeutic treatments to a single room with said equipment disposed in a side-by-side relationship; and
iii) undergoing therapeutic treatment with said equipment and a masseur person.

2. A method for selling therapeutic treatment packages for any one of home, hotel, or condo use, comprising the steps of:
i) providing equipment for at least two complementary therapeutic treatments;
ii) confining said equipment for said at least two complementary therapeutic treatments to a demonstration room; and
iii) selling packages of equipment as shown in said demonstration room.

3. The method according to claim 2, wherein said equipment for said at least two complementary treatments are hot-air enclosure, air-jet water bath and massage table.
